(19) United States
(12) Patent Application Publication
(10) Pub. No.: US 2001/0015095 A1
(43) Pub. Date: Aug. 23, 2001

(54) Viscosity measuring apparatus

(75) Inventor: Yasunori Konaka, Uji-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 09/771,712

(22) Filed: Jan. 30, 2001

(30) Foreign Application Priority Data
Feb. 22, 2000 (JP) 2000-044661

(51) Int. Cl. G01N 11/14

(52) U.S. Cl. 73/54.32; 73/54.28

(57) ABSTRACT

In a viscosity measuring apparatus, a time for restoring to a set temperature from a lowered temperature in a material chamber when a material is filled in the chamber can be selected. Thus, a temperature rising speed of the material can be freely set to measure a viscosity. Therefore, it is possible to measure the viscosity when the material, such as rubber, is heated at the temperature rising speed in conformity with an actual molding condition. Also, in order to compare a result measured in the past, it is possible to measure the viscosity when the material is heated at the temperature rising speed in conformity with the past measuring condition.

### BACKGROUND OF THE INVENTION AND RELATED ART STATEMENT

The invention relates to a viscosity measuring apparatus for measuring a viscosity of a high molecular material, such as rubber, more particularly, to a viscosity measuring apparatus where a viscosity resistance of a material is measured to measure the viscosity.

As a method for measuring a viscosity of rubber or the like, for example, there has been known a method, wherein under a condition that a material chamber is filled with a material and held at a predetermined temperature, a viscosity resistance generated when a rotor is rotated in the material chamber is measured as a Mooney viscosity.

In a viscosity measuring apparatus of this type, generally, a material chamber is formed between upper and lower dies which can be moved close to and away from each other, and a rotor fixed to a forward end of a shaft passing through one of the dies is rotatably disposed in the material chamber. A counter torque acting when the rotor is rotated is detected by a detector disposed outside the material chamber through the shaft. Also, a temperature in the material chamber is detected by temperature sensors, and heaters provided at the respective dies are feed-back controlled by using the detected outputs to thereby control the temperature in the material chamber to a set temperature.

The temperature in the material chamber is controlled by a method, such as PID control, and the heaters are controlled so that the detected results of the temperature by the temperature sensors always coincide with the set temperature under a predetermined control.

When the viscosity of the material is measured by the viscosity measuring apparatus as described above, a material under a standard condition is filled in the material chamber controlled at a set temperature. Since the temperature in the material chamber is lowered by filling the material therein, the temperature is restored to the set temperature. When a preheat time is completed, the rotor is rotated to measure a counter torque thereof and obtain a viscosity resistance of the material under the set temperature.

However, depending on a kind of the material, even if a measurement at the same set temperature is carried out, the viscosity resistance may differ according to a temperature rising speed when the material is heated from a standard condition to the set temperature. With respect to such a material, for example, when the result measured in the past by using other measuring apparatus, though the measuring apparatus is the same kind, is compared with the result newly measured, if the temperature rising speeds of the materials are different in the respective measuring apparatuses, the obtained viscosities are different from each other, so that comparison of the two viscosities can not be made simply.

Also, with respect to the above-mentioned material, for example, there is a case where a viscosity when the material is heated to a set temperature at a temperature rising speed in conformity with the actual molding condition, is sought. However, in the conventional measuring apparatus, since the material is heated to the set temperature under a predetermined control, a measurement according to a desired object can not be carried out.

The present invention has been made to solve the above-mentioned problems, and an object of the invention is to provide a viscosity measuring apparatus, wherein a temperature in a material chamber formed of upper and lower dies can be raised from a normal condition to a set temperature at any selected time, so that a viscosity of a material, such as rubber, heated to the set temperature at a temperature rising speed in conformity with an actual molding condition can be measured.

Another object of the invention is to provide a viscosity measuring apparatus as stated above, wherein a viscosity can be measured under the same heating conditions as those measured in the past to compare the results.

Further objects and advantages of the invention will be apparent from the following description of the invention.

### SUMMARY OF THE INVENTION

A viscosity measuring apparatus of the invention includes a material chamber formed of upper and lower dies; a rotor fixed to a forward end of a shaft passing through either one of the upper and lower dies to be rotated in the material chamber; a temperature controlling device including a plurality of temperature sensors for detecting a temperature in the material chamber, and controlling the temperature in the material chamber to a set temperature upon receiving outputs from the temperature sensors; and a torque detecting device for detecting a counter torque acting on the rotor so that when the rotor is rotated under a condition where the material chamber is filled with a material and controlled to a predetermined temperature, a viscosity resistance of the material can be obtained from the counter torque acting on the rotor. In the temperature controlling device, a time for restoring, to a set temperature, the temperature in the material chamber lowered when the material in a standard condition is filled in the material chamber, can be selected.

### BRIEF DESCRIPTION OF THE DRAWINGS

FIG. 1 is a structural diagram showing an embodiment of the invention, wherein a mechanical structure and a block diagram of an electrical structure are combined; and

FIGS. 2(A) and 2(B) are graphs showing temperature restoring processes in a material chamber of an embodiment according to the invention, wherein FIG. 2(A) shows a case where a relatively short temperature restoring time is set; and FIG. 2(B) shows a case where a relatively long temperature restoring time is set.

### DETAILED DESCRIPTION OF PREFERRED EMBODIMENTS

Hereinafter, an embodiment of the present invention is explained with reference to the accompanying drawings.

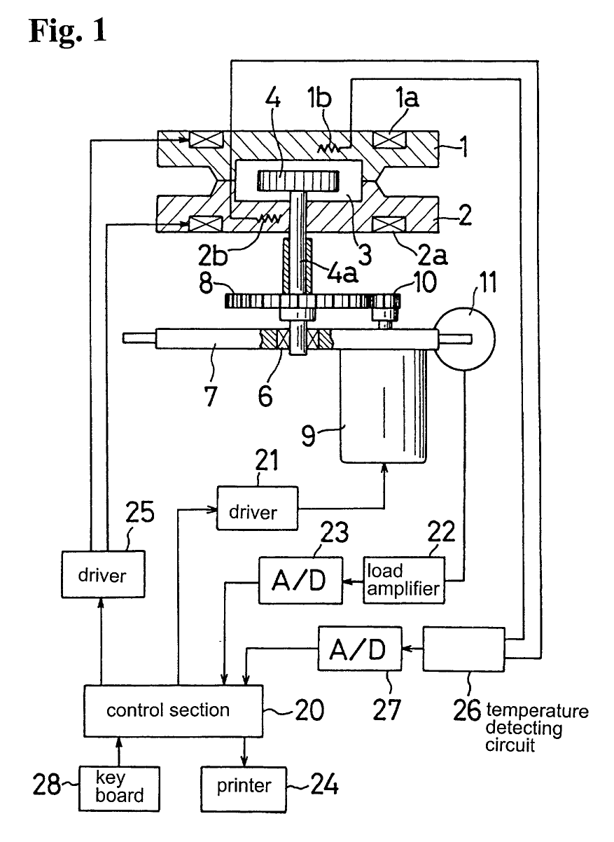

FIG. 1 is a diagram showing an embodiment of the invention, wherein a mechanical structure and a block diagram of an electrical structure are combined.

A sample chamber 3 is formed of a cylindrical space between an upper die 1 and a lower die 2, and a rotor 4 is disposed at a central portion thereof. The rotor 4 is fixed to an upper edge of a rotor shaft 4a fluid-tightly penetrating through the lower die 2, and the rotor shaft 4a is rotatably supported by a supporting plate 7 through a bearing 6 in a vicinity of a lower edge thereof. Also, the rotor shaft 4a is provided with a driven gear 8. The driven gear 8 is engaged with a driving gear 10 fixed to an output shaft of a driving motor 9, thus providing rotation to the rotor 4 through rotation of the driving motor 9. The driving motor 9 is controlled by a control signal supplied from a driver 21 operated based on a command signal from a control portion 20 mainly composed of a microcomputer.

The support plate 7 supports the rotor shaft 4a through the bearing 6, as described above, and at the same time, the support plate 7 is rotatably supported around the bearing 6. Also, an outer edge portion of the supporting plate 7 is engaged with a force sensitive portion of a load cell 11. With the structure, a counter torque produced by a rotation of the rotor 4 allows the supporting plate 7 to rotate around the bearing 6 through the rotor shaft 4a. The force sensitive portion of the load cell 11 is pressed through the rotation of the supporting plate 7 to thereby detect the counter torque acting on the rotor 4 from an output of the load cell 11. After the output of the load cell 11 is amplified by a load amplifier 22, it is digitized by an A/D converter 23 and is sampled at a control portion 20 from time to time. The control portion 20 sequentially stores, in a memory, results of the counter torques measured from time to time, and at the same time, outputs to a printer 24 to record.

The upper and lower dies 1, 2 are provided with heaters 1a, 2a and temperature sensors 1b, 2b, respectively, and the respective heaters 1a, 2a are controlled by controlling signals supplied from a driver 25 under the control of the control portion 20. Outputs of the respective temperature sensors 1b, 2b are supplied to an A/D converter 27 through a temperature detecting circuit 26 to be digitized, and then taken into the control portion 20 from time to time. In the control portion 20, through a normal PID operation using the outputs of the respective temperature sensors 1b, 2b, controlling signals to be supplied momentarily to the heaters 1a, 2a are determined so that the output values of the respective temperature sensors 1b, 2b, i.e. temperature in the material chamber 3 surrounded by the upper die 1 and the lower die 2, coincide with a target temperature (hereinafter referred to as “set temperature”) which has been set beforehand by a key board 28, and a command is applied to the driver 25.

After a temperature in the empty material chamber 3 reaches the set temperature thereof, when a material in a standard condition determined by a specification or the like is filled in the material chamber 3, the temperature in the material chamber 3 is lowered. In this condition, a time required for restoring the lowered temperature to the set temperature can be set through the key board 28.

More specifically, in order to restore the temperature lowered in the material chamber 3 caused when the material in the standard condition is filled in the material chamber 3, to the set temperature, when a control command is applied to the driver 25 of the heaters 1a, 2a, the control portion 20 produces a target value at that time to eliminate the difference between the set value and the temperature in the material chamber 3 through a time set by the key board 28, and supplies controlling signals to the heaters 1a, 2a through the driver 25 so that the temperature in the material chamber 3 follows the target value.

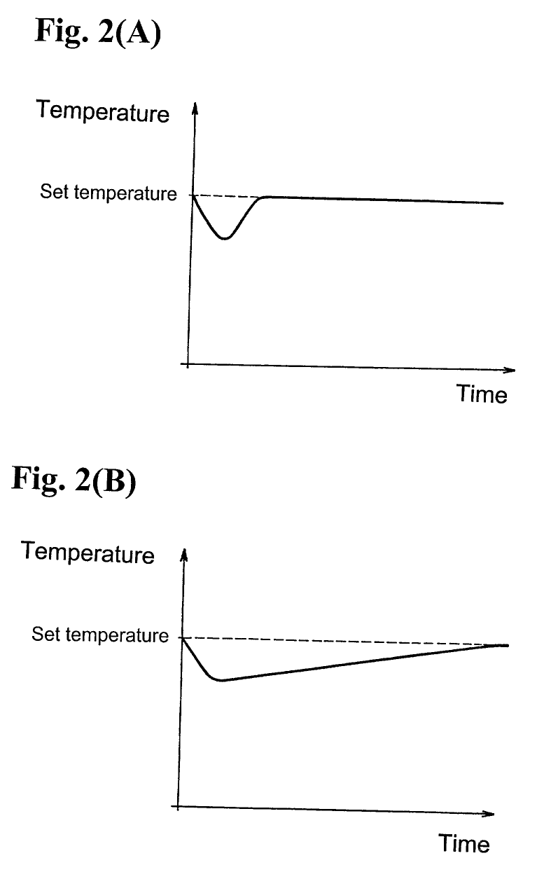

Therefore, a rising speed of the temperature in the material chamber 3 varies as shown in FIG. 2(A) where a restoring time is set relatively short, and as shown in FIG. 2(B) where the restoring time is set relatively long. Thus, it is possible to measure the viscosity of the material when it is heated at a rising speed in conformity with an actual molding condition, or it is possible to measure a viscosity of the material when it is heated at the same temperature rising speed as the data measured in the past and stored, and to compare therewith.

Incidentally, after the material is filled in the material chamber 3 and the temperature therein reaches the set temperature, in the same manner as in the conventional measuring apparatus, the rotor 4 is rotated at a specified speed while holding the temperature in the material chamber 3 at the set temperature, so that the viscosity of the material can be obtained from the counter torque acting on the rotor 4.

Here, as a method for setting the time required for restoring the temperature in the material chamber 3 to the set temperature after the material is filled therein, in addition to the method where a desired time is set through the key board 28, it is also possible to select a time from a plurality of times stepwisely set beforehand.

Also, as a method for controlling the heaters 1a, 2a when the temperature in the material chamber 3 is restored to the set temperature through the set time, in addition to the method where a target value is set first to follow it as described above, it is also possible to apply a simplified method where respective constants of PID controls, especially, the constant of the proportional operation, are changed.

As described above, according to the present invention, the time required for restoring to the set temperature from the temperature in the material chamber, which was once held at the set temperature and lowered by filling therein the material in the standard condition, can be set at a desired value. Thus, the viscosity measuring apparatus of the invention can be used for measuring a viscosity of a material by heating the material at a temperature rising speed in conformity with an actual molding condition of the material, and measuring a viscosity of a material heated at the same temperature rising speed as that when measured in the past to compare the results. Thus, the present invention can be used widely when compared with the conventional viscosity measuring apparatus of this type.

While the invention has been explained with reference to the specific embodiment of the invention, the explanation is illustrative and the invention is limited only by the appended claims.

What is claimed is:

1. A viscosity measuring apparatus, comprising:
a material chamber for receiving a material to be measured,
a rotor rotatably situated in the material chamber,
a torque detecting device attached to the rotor for detecting a counter torque acting on the rotor, said torque detecting device obtaining a viscosity resistance of a material in the material chamber from the counter torque acting on the rotor when the rotor is rotated under a condition that the material chamber is filled with the material and controlled at a predetermined temperature, and
a temperature controlling device including a temperature sensor for detecting a temperature in the material chamber, a control section for receiving an output from the temperature sensor and controlling a temperature in the material chamber to a set temperature, and means for selectively setting a time for restoring a temperature in the material chamber lowered when the material in a standard condition is filled in the material chamber to the reset temperature.

2. A viscosity measuring apparatus according to claim 1, wherein said material chamber is formed of upper and lower dies, and the rotor includes a shaft passing through one of the upper and lower dies, said rotor being attached to an end of the shaft to be rotated in the material chamber and the torque detecting device being attached to the other end of the shaft.

3. A viscosity measuring apparatus according to claim 2, wherein said control section includes heaters attached to the upper and lower dies to heat the same, and a controller connected to the temperature sensor, the heaters and the setting means for controlling the same

4. A viscosity measuring apparatus according to claim 3, wherein said controller includes a plurality of setting time charts determined in advance for restoring the temperature in the material chamber.
